(19) United States
(12) Patent Application Publication
(10) Pub. No.: US 2018/0118523 A1
(43) Pub. Date: May 3, 2018

(54) FOLDING ASSEMBLY FOR AN ACTUATION LEVER

(71) Applicant: Caterpillar Inc., Peoria, IL (US)

(72) Inventors: Harikumar Chellaswamy, Chennai (IN); Sreejith Sreedharan, Pathanamthitta (IN)

(73) Assignee: Caterpillar Inc., Peoria, IL (US)

(21) Appl. No.: 15/337,393

(22) Filed: Oct. 28, 2016

(51) Int. Cl. B66C 13/56; G05G 1/04

(52) U.S. Cl. CPC B66C 13/56; A01G 23/003; G05G 1/04

(57) ABSTRACT

A folding assembly for an actuation lever is disclosed. The folding assembly includes a first shaft and a second shaft pivotally coupled to the first shaft. The second shaft includes a first engagement structure and a second engagement structure spaced apart from the first engagement structure. The folding assembly further includes a sleeve slidably disposed around the first shaft and the second shaft. The sleeve comprises a mating structure adapted to engage with the first engagement structure or the second engagement structure. The sleeve is adapted to cover a portion of the first shaft and a first portion of the second shaft, when the mating structure is engaged with the second engagement structure. Further, the sleeve is adapted to cover a second portion of the second shaft such that the sleeve releases the first shaft, when the mating structure is engaged with the first engagement structure.

### TECHNICAL FIELD

The present disclosure, in general, relates to an actuation lever. More specifically, the present disclosure relates to a folding assembly for the actuation lever.

### BACKGROUND

Various off-road machines such as forestry dump truck may have an implement coupled to a linkage assembly. Typically, the implement is actuated through the linkage assembly to perform a task at a worksite. Usually, the actuation of the implement is controlled by means of an actuation lever such as a joystick. The operator may operate the joystick to actuate the linkage assembly and, accordingly, perform the task.

During operation of the machine, in certain scenarios, debris may fall on the joystick and therefore may damage the joystick. For example, the forestry dump truck (hereinafter referred to as dump truck), adapted to operate in a forest area to haul tree logs, includes an open operator cabin having one or more joysticks. As the operator cabin is open, there may be a possibility of debris (such as tree branches) falling on the joystick, which may damage the joystick. Such damaged joysticks are usually replaced as whole that may result in a cost overhead. Additionally, the damage to the joystick may delay the overall operation at the worksite.

Japanese Patent Application JPH04140328 (hereinafter referred as '328) discloses that a second rod is pivotally attached by pins to the first rod. A rotation regulator is attached to the pivotal part of the rods. The rods are integrated by regulating the upward movement of regulator. The rotation regulator is rotated toward the second rod and, accordingly, the second rod is folded in relation to the first rod.

### SUMMARY

According to various aspects of the disclosure, a folding assembly for an actuation lever is disclosed. The folding assembly includes a first shaft. Further, the folding assembly includes a second shaft pivotally coupled to the first shaft to allow articulation of the second shaft relative to the first shaft. The second shaft includes a first engagement structure. Further, the second shaft includes a second engagement structure spaced apart from the first engagement structure. The folding assembly further includes a sleeve slidably disposed around the first shaft and the second shaft. The sleeve comprises a mating structure adapted to engage with the first engagement structure or the second engagement structure. The sleeve is adapted to cover a portion of the first shaft and a first portion of the second shaft, when the mating structure is engaged with the second engagement structure. Further, the sleeve is adapted to cover a second portion of the second shaft such that the sleeve releases the first shaft, when the mating structure is engaged with the first engagement structure.

According to various aspects of the disclosure, a joystick assembly is disclosed. The joystick assembly includes a joystick handle. Further, the joystick assembly includes a folding assembly. The folding assembly comprises a first shaft. Further, the folding assembly includes a second shaft having a first end portion and a second end portion. The first end being adapted to receive the joystick handle. The second shaft is pivotally coupled to the first shaft at the second end portion to allow articulation of the second shaft and the joystick handle relative to the first shaft. The second shaft includes a first groove formed on an outer surface of the second shaft. The second shaft further includes a second groove formed on the outer surface of the second shaft. The second groove is spaced apart from the first groove. The folding assembly additionally includes a sleeve slidably disposed around the first shaft and the second shaft. The sleeve includes a ball-catch assembly adapted to engage with the first groove or the second groove. The sleeve is adapted to cover a portion of the first shaft and a first portion of the second shaft, when the ball-catch assembly is engaged with the second groove. The sleeve is adapted to cover a second portion of the second shaft such that the sleeve releases the first shaft, when the ball-catch assembly is engaged with the first groove.

According to various aspects of the disclosure a joystick assembly is disclosed. The joystick assembly includes a joystick handle. Further, the joystick assembly includes a folding assembly. The folding assembly includes a first shaft. The folding assembly further includes a second shaft having a first end portion and a second end portion. The first end being adapted to receive the joystick handle. The second shaft is pivotally coupled to the first shaft at the second end portion to allow articulation of the second shaft and the joystick handle relative to the first shaft. The second shaft includes a first groove formed on an outer surface of the second shaft. Further, the second shaft includes a second groove formed on the outer surface of the second shaft. The second groove is spaced apart from the first groove. The folding assembly further includes a sleeve slidably disposed around the first shaft and the second shaft. The sleeve includes a ball-catch assembly adapted to engage with the first groove or the second groove. The sleeve is adapted to cover a portion of the first shaft and a first portion of the second shaft, such that the articulation of the second shaft is restricted by the sleeve, when the ball-catch assembly is engaged with the second groove. The second shaft is in an upright state when the ball-catch assembly is engaged with the second groove. The sleeve is adapted to cover a second portion of the second shaft such that the sleeve releases the first shaft, such that the articulation of the second shaft is allowed, when the ball-catch assembly is engaged with the first groove. The second shaft is adapted to be in a folded state when the ball-catch assembly is engaged with the first groove. The folding assembly further includes a clip adapted to restrict the articulation of the second shaft and the joystick handle when the second shaft is in the folded state.

### BRIEF DESCRIPTION OF THE DRAWINGS

FIG. 1 is a diagrammatic view of a machine including an actuation lever, in accordance with the concept of the present disclosure;

FIG. 2 is an exploded view of a folding assembly for the actuation lever, in accordance with the concept of the present disclosure;

FIG. 3 is an enlarged cross-sectional view of the folding assembly shown in a locked condition, in accordance with the concept of the present disclosure;

FIG. 4 is an enlarged cross-sectional view of the folding assembly shown in an unlocked condition, in accordance with the concept of the present disclosure; and

FIG. 5 is a perspective view of the actuation lever in a folded state, in accordance with the concept of the present disclosure.

### DETAILED DESCRIPTION

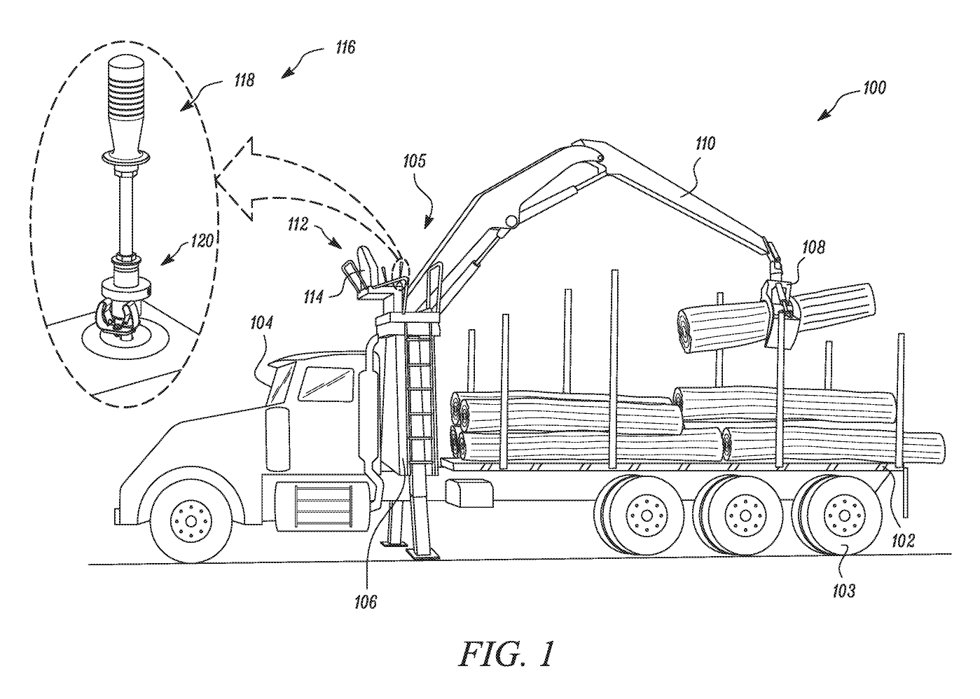

Referring to FIG. 1, in one embodiment, the machine 100 corresponds to a forestry dump truck adapted to haul tree logs. The machine 100 includes a payload carrier 102, a plurality of traction members 103, a first operator cabin 104, and a loading/unloading assembly 105. The loading/unloading assembly 105 further includes an A-frame 106, an implement 108, a linkage assembly 110, and a second operator cabin 112. The second operator cabin 112 further includes a seat 114, one or more actuation levers 116a and 116b (hereinafter referred to as the actuation lever 116). One of ordinary skill in the art would appreciate that the scope of the disclosure is not limited to the machine 100 as the forestry dump truck. The machine 100 may correspond to any machine that includes an operator cabin having the actuation lever 116. Further, the person having ordinary skill in the art would appreciate that the scope of the disclosure is not limited to having two operator cabins 104, and 106. In an embodiment, the machine 100 may have only one operator cabin that has the actuation lever 116.

The payload carrier 102 corresponds to a dump body (or a dump bed) that is adapted to receive and store the payload (for example tree logs) for the purpose of transportation of the payload. The payload carrier 102 is supported on a plurality of traction members 103 of the machine 100. In an embodiment, the payload carrier 102 is designed according to the weight carrying capability of the machine 100. The payload carrier 102 has a rear end and a front end. The rear end of the payload carrier 102 forms the rear end of the machine 100.

The first operator cabin 104 corresponds to a driver cabin that includes one or more components that enable an operator of the machine 100 to drive the machine 100 along a path. For example, the first operator cabin 104 includes a steering wheel, an accelerator paddle, and a brake paddle. The operator may utilize the steering wheel, the accelerator paddle and the brake paddle to drive the machine 100 along an operational path.

The A-frame 106 is removably attached to the frame of the machine 100 between a rear end of the first operator cabin 104 and the front end of the payload carrier 102. The A-frame 106 includes support structures that are adapted to provide support to the A-frame 106 on the ground. Further, the A-frame 106 is coupled to the linkage assembly 110 that is adapted to support the implement 108. The linkage assembly 110 may include one or more arms that may be actuated either individually or in combination to move the implement 108 along one or more paths to pick up and load the material on the machine 100. For example, the linkage assembly 110 may be actuated to load or unload tree logs to or from the machine 100.

Additionally, the A-frame 106 further supports the second operator cabin 112 placed on a platform disposed on a top of the A-frame 106. The second operator cabin 112 includes the seat 114 that is adapted to provide a seating for the operator. Further, the second operator cabin 112 includes the actuation lever 116 that may attached to the seat 114. In another example, the actuation lever 116 are attached to the platform of the second operator cabin 112. The operator of the machine 100 may utilize the actuation lever 116 to actuate the linkage assembly 110 and the implement 108. Some examples of the actuation lever 116 include, but are not limited to, a joystick assembly, a gear lever assembly, etc. For the purpose of ongoing description, the actuation lever 116 has been considered as the joystick assembly 116. However, it may be contemplated that the ongoing description is applicable on the other types of actuation lever 116.

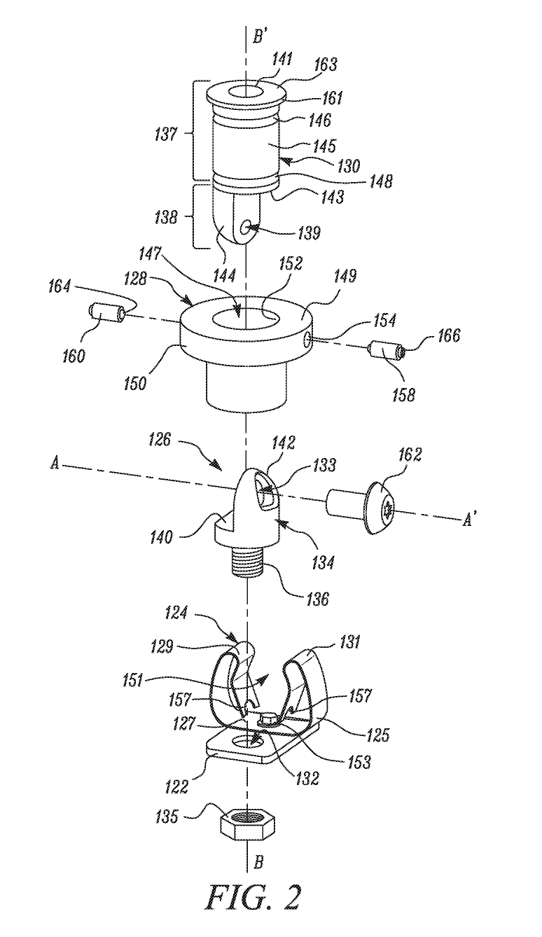

The joystick assembly 116 includes a joystick handle 118 and a folding assembly 120. The joystick handle 118 is coupled to the folding assembly 120. The coupling of the joystick handle 118 to the folding assembly 120 has been described below in conjunction with FIG. 2.

Referring FIG. 2, an exploded view of the folding assembly 120, is illustrated. The folding assembly 120 includes a base plate 122, a clip 124, a first shaft 126, a sleeve 128, and a second shaft 130, mating structures 158 And 160, and a hinge joint pin 162.

The first shaft 126 includes a joint portion 134 and a rod portion 136. The rod portion 136 is coupled to the seat 114 in such a manner that the first shaft 126 is movable with respect to the seat 114. The movement of the first shaft 126, with respect to the seat 114, is used to control the movement of the linkage assembly 110 and the implement 108. In an example, the rod portion 136 may be coupled to the seat 114 through the base plate 122. The base plate 122 may be affixed to the seat 114 and may include a through hole 132. The rod portion 136 passes through the through hole 132 and is coupled to the seat 114. In one example, the rod portion 136 may define threads that may be utilized to couple the rod portion 136 with the base plate 122. In another example, the first shaft 126 may be welded with the base plate 122 at an interface defined between the joint portion 134 and the rod portion 136. Prior to welding the joint portion 134 with the base plate 122, a nut 135 may be received by the rod portion 136 (i.e. to a bottom of the base plate 122) to fix an orientation of the first shaft 126 with respect to the base plate 122. Thereafter, the base plate 122 may be welded with the joint portion 134.

The clip 124 is mounted to the base plate 122. In one example, the clip 124 may be formed of a metal strip 125 that is bent from either sides to form a substantially U-shaped structure. The clip 124 includes a base portion 127 and a pair of stems 129, 131. The base portion 127 of the clip 124 is adapted to be coupled to the base plate 122 by a nut-bolt assembly 153, while the pair of stems 129 and 131 are symmetrically opposed to each other, about the base portion 127, thus defining the U-shaped structure of the clip 124. In another implementation, the base portion 127 is welded to the base plate 122. The pair of stems 129, 131 are further bent inwards to the clip 124, such that ends 157 of the metal strip 125 point towards the base portion 127. In so doing, an inner space 151 is defined by the pair of stems 129 and 131 that is adapted to receive the joystick handle 118. The pair of stems 129 and 131 may act as resilient members relative to the base portion 127 that allows the joystick handle 118 to snap into the inner space 151 so as to receive, engage, and retain the joystick handle 118, when required.

Referring back to the first shaft 126, the joint portion 134 of the first shaft 126 is defined as a step structure that includes a base 140 and a wall 142 that extends from the base 140 along an axis B-B′. In an embodiment, the wall 142 may have a hemispherical profile. However, it may be contemplated that the wall 142 may have other profiles such as an elliptical profile. The surface of the wall 142 defines a through hole 133, substantially perpendicular to the axis B-B′, that is adapted to receive a hinge joint pin 162 to pivotally engage the first shaft 126 with the second shaft 130.

The second shaft 130 includes a first end portion 137 and a second end portion 138. The second end portion 138 of the second shaft 130 is defined as the step structure that includes a base 143 and a wall 144. In an embodiment, the profile of the wall 144, of the second shaft 130, is similar to the profile of the wall 142 of the first shaft 126. Further, the surface of the wall 142 of the first shaft 126 defines an opening 139. When the first shaft 126 is assembled with the second shaft 130, the wall 144 of the second shaft 130 may be disposed adjacent to the wall 142 of the first shaft 126 in such a manner that the opening 139 may align with the through hole 133 to allow the hinge joint pin 162 to pass through both the opening 1

39 and the through hole 133, thereby pivotally coupling the wall 144 with the wall 142, and, in turn, pivotally coupling the first shaft 126 with the second shaft 130. Further, the pivotally coupling of the first shaft 126 with the second shaft 130 allows the second shaft 130 to be articulated (on application of force) with respect to the first shaft 126 around an axis A-A′.

The first end portion 137 of the second shaft 130 defines a recess 141 at an end 163 of the second shaft 130. The recess 141 is adapted to threadbly receive the joystick handle 118 to engage the joystick handle 118 with the folding assembly 120. In some implementations, the joystick handle 118 may a nut 165 to fasten the joystick handle 118 with the second shaft 130. Further, the first end portion 137 of the second shaft 130 has an outer surface 145 that defines a first engagement structure 146 and a second engagement structure 148. The first engagement structure 146 is spaced apart from the second engagement structure 148. Further, the second engagement structure 148 is proximate to the second end portion 138. Furthermore, the first engagement structure 146 is formed distal from the second end portion 138. As shown in FIG. 2, the first engagement structure 146 and the second engagement structure 148 are illustrated as grooves formed circumferentially on the outer surface 145 of the first end portion 137. However, it may be contemplated that the first engagement structure 146 and the second engagement structure 148 may correspond a recess defined on the outer surface 145 of the first end portion 137. The first end portion 137 of the second shaft 130 further includes a stopper plate 161 disposed at the end 163 of the second shaft 130.

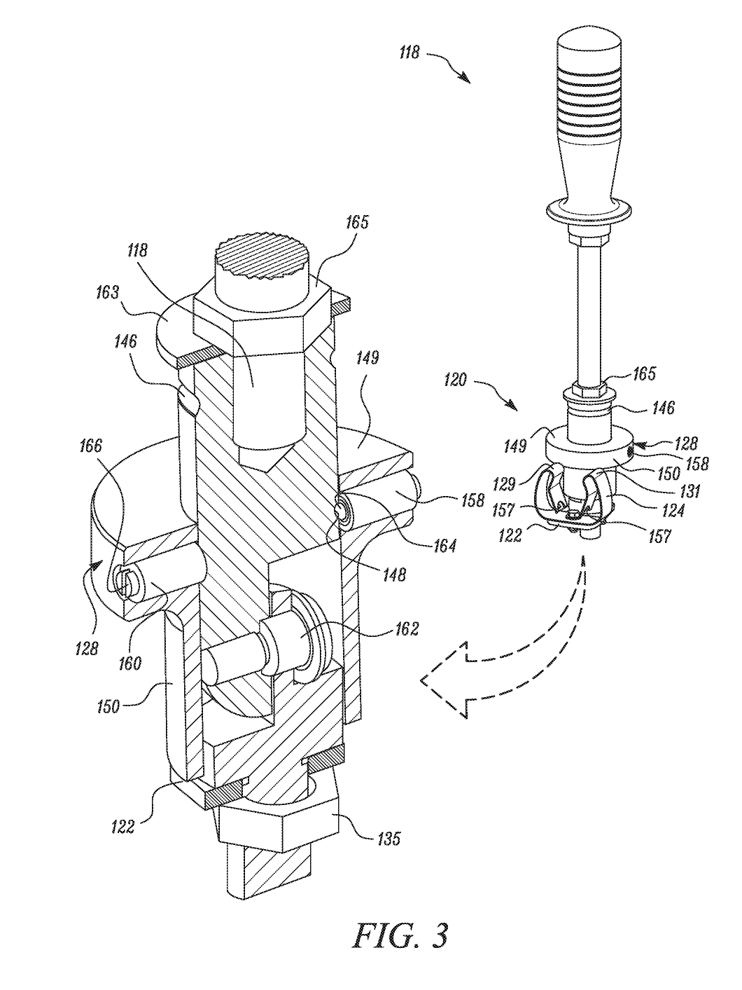

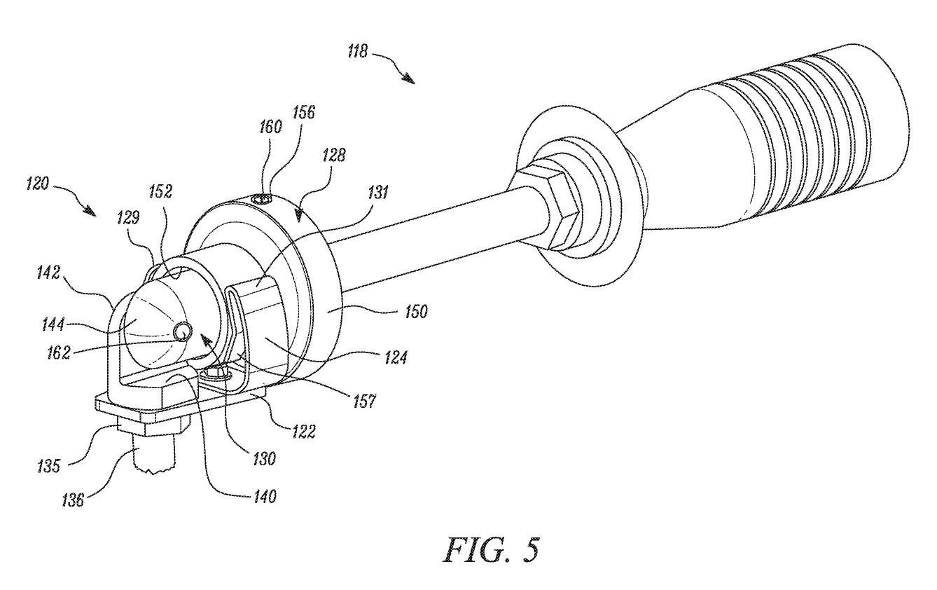

Referring to FIG. 3, the sleeve 128 is slidably disposed around the second shaft 130. The sleeve 128 has an opening 147 defining an inner surface 152. Further, the sleeve 128 has an outer surface 150. The inner surface 152 of the sleeve 128 is proximate to the outer surface 145 of the second shaft 130. Further, the sleeve 128 includes a first bore 154 that extends from the outer surface 150 of the sleeve 128 to the inner surface 152 of the sleeve 128. The sleeve 128 may further include a second bore 156 (refer FIG. 5) that extends from the outer surface 150 of the sleeve 128 to the inner surface 152 of the sleeve 128. Further, the second bore 156 (refer FIG. 5) is defined to be diametrically opposite to the first bore 154 in such a manner that the first bore 154 and the second bore 156 have a common longitudinal axis. Furthermore, the longitudinal axis of the first bore 154 and the second bore 156 is perpendicular to the longitudinal axis of the sleeve 128. In an alternate embodiment, the first bore 154 and the second bore 156 may correspond to a blind bore that are open at the inner surface 152 of the sleeve 128.

The outer surface 150 of the sleeve 128 defines a flange 149 that extends in both radial and axial direction. The extension of the flange 149 in the axial direction defines a width of the flange 149. Further, the extension of the flange 149 in the radial direction defines a diameter of the flange 149. In an embodiment, the first bore 154 and the second bore 156 are defined on the flange 149.

The first bore 154 and the second bore 156 are adapted to receive mating structures 158 and 160, respectively. The mating structures 158 and 160 are adapted to engage with the first engagement structure 146 or the second engagement structure 148. The engagement of the mating structures 158 and 160 with the first engagement structure 146 or the second engagement structure 148 restricts an axial movement of the sleeve 128. In an embodiment, on application of axial force on the sleeve 128, the mating structures 158 and 160 disengage the first engagement structure 146 or the second engagement structure 148 to allow the axial movement of the sleeve 128. The mating structures 158 and 160 automatically engages with the first engagement structure 146 or the second engagement structure 148 based on the position of the sleeve 128 with respect to the second shaft 130.

As illustrated in FIG. 2, a ball-catch assembly may be utilized as the mating structures 158 and 160 to facilitate automatic engagement of the mating structures 158 and 160 with the first engagement structure 146 or the second engagement structure 148 based on the position of the sleeve 128 with respect to the second shaft 130. The ball catch assembly (for example, ball catch assembly 158) includes a ball 164 that is adapted to roll on an outer surface 145 of the second shaft 130, along a longitudinal axis of the second shaft 130. As well known, the ball 164 may be resiliently held within a chamber of the ball catch assembly 158, and may be at least partially extended outwards of the ball catch assembly 158 to bias and roll against the outer surface 145 of the second shaft 130. The ball-catch assemblies 158 and 160 are threadably received in the first bore 154 and the second bore 156, respectively, in such a manner that a ball 164 of the ball-catch assembly protrudes out from the inner surface 152 of the sleeve 128. In some implementations, a screw head 166 may be defined on the other end of the ball-catch assemblies 158 and 160 (i.e., end opposite to the ball 164) to assist threadable reception of the ball-catch assemblies 158 and 160 in the first bore 154 and the second bore 156.

When the ball-catch assemblies 158 and 160 are neither engaged with either the first engagement structure 146 nor the second engagement structure 148, the ball 164 of the ball-catch assemblies 158 and 160 is in contact with the outer surface 145 of the second shaft 130 and the bias member may be in a compressed state. Conversely, when the ball-catch assemblies 158 and 160 are engaged with either of the first engagement structure 146 or the second engagement structure 148, an axial force may need to be applied to compress and move the ball 164 of the ball-catch assemblies 158 and 160 from either the first engagement structure 146 or the second engagement structure 148 to the outer surface 145. The ball 164 rolls on the outer surface 145 allowing the sleeve 128 to relatively smoothly move in an axial direction along the second shaft 130. A biasing action (both compression and extension) of the ball 164 relative to the first engagement structure 146 or the second engagement structure 148 may be defined along a longitudinal axis of the ball-catch assemblies 158 and 160. It may be contemplated that the scope of the disclosure is not limited to the sleeve 128 having the ball catch assembly 158, and the second shaft 130 defining the grooves (i.e., first engagement structure 146 or the second engagement structure 148). In an alternate embodiment, the groove may be defined on the inner surface 152 of the sleeve 128. In such a scenario, bores may be defined in the second shaft 130 to receive the ball catch assemblies 158 and 160. To this end, the ball catch assembly in the second shaft 130 may engage with the groove defined on the inner surface 152 of the sleeve 128, to restrict axial movement of the sleeve 128. Further, it may be contemplated that the scope of the disclosure is not limited to ball-catch assembly as the mating structures 158 and 160. In an embodiment, the mating structure 158 and 160 may correspond to the a screw, a shaft, or any other structure that is adapted to engage with the first engagement structure 146 or the second engagement structure 148.

It may be further contemplated that the scope of the disclosure is not limited to define the first engagement structure 146 and the second engagement structure 148 on the second shaft 130. In an embodiment, the first engagement structure 146 and the second engagement structure 148 may be defined around the first shaft 126. In such a scenario, the sleeve 128 may be slidably disposed around the first shaft 126 and the mating structures 158 and 160 may be adapted to engage with the first engagement structure 146 or the second engagement structure 148 defined on the first shaft 126. In yet another embodiment, one of the first engagement structure 146 or the second engagement structure 148 may be defined on the first shaft 126 and the other engagement structure may be defined on the second shaft 130. In such a scenario, the sleeve 128 may be slidably disposed around both the first shaft 126 and the second shaft 130. For the purpose of ongoing description, the first engagement structure 146 and the second engagement structure 148 have been considered to be defined on the second shaft 130.

In an embodiment, the joystick assembly 116 may be configured in at least on an upright state or a folded state. As shown in FIG. 3, in the upright state, the mating structures 158 and 160 are engaged with the second engagement structure 148. Further, the sleeve 128 covers a portion of the second shaft 130 and a portion of the first shaft 126. In an embodiment, the sleeve 128 covers the joint portion 134 of the first shaft 126, when the mating structures 158 and 160 are engaged with the second engagement structure 148. In alternate embodiment, the sleeve 128 covers the joint portion 134 and a portion of the rod portion 136, when the mating structures 158 and 160 are engaged with the second engagement structure 148. As the sleeve 128 covers the joint portion 134 of the first shaft 126, the articulation movement of the second shaft 130 around the pivot joint is restricted. Therefore, the second shaft 130 is in the upright state.

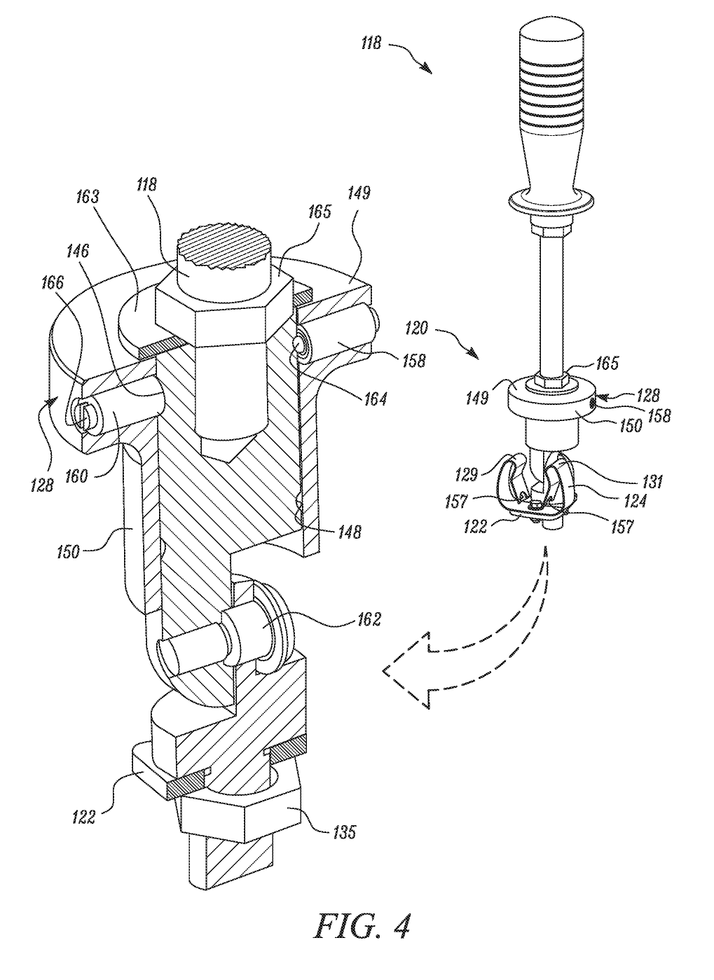

Referring to FIG. 4 and FIG. 5, when configuring the joystick assembly 116 in the folded state, the mating structures 158 and 160 in the sleeve 128 are engaged with the first engagement structure 146. When the mating structures 158 and 160 are engaged with the first engagement structure 146, the sleeve 128 covers only the portion of the second shaft 130. In an embodiment, in such a scenario, the sleeve 128 releases the first shaft 126. For example, the sleeve 128 releases the joint portion 134 of the first shaft 126. Therefore, the second shaft 130 can be articulated around the axis A-A′ on application of force. For example, on application of the force on the joystick handle 118, the joystick handle 118 (coupled with the second shaft 130) may be adapted to be articulated to the folded state. Further, in the folded state, the sleeve 128 around the second shaft 130 engages with the clip 124 in such a manner that the clip 124 restricts the articulation movement of the joystick handle 118 and the second shaft 130 (refer FIG. 5). In an embodiment, the joystick handle 118 snaps into the inner space 151. Further, the pair of stems 129 and 131 abuts with the sleeve 128 in such a manner that the articulation movement of the joystick handle 118 is restricted. To disengage the joystick handle 118, a force may be applied to move the pair of stems 129 and 131 away from each other in opposite directions such that the pair of stems 129 and 131 releases the joystick handle 118. When the force is removed, the pair of stems 129 and 131 return to their default position.

### INDUSTRIAL APPLICABILITY

When the operator of the machine 100 has to load or unload the payload to or from the machine 100, the operator of the machine 100 may utilize the joystick assembly 116 to actuate the implement 108. Prior to operating the joystick assembly 116, the operator may release the joystick assembly 116 from the clip 124 and may articulate the joystick handle 118 to an upright position. Thereafter, the operator may apply force on the flange 149 of the sleeve 128 to move the sleeve 128 axially towards the second end portion 138 of the second shaft 130. The sleeve 128 slides on the second shaft 130 until the mating structures 158 and 160 (i.e., the ball catch assembly 158 positioned inside the first bore 154 and the second bore 156) engage with the second engagement structure 148 (i.e., the groove). On engagement of the mating structures 158 and 160 with the second engagement structure 148, the sleeve 128 covers the pivot joint and therefore restricting the articulation movement of the joystick handle 118. Thereafter, the operator may operate the joystick assembly 116 to actuate the implement 108.

When the joystick assembly 116 is not being used to operate the implement 108, the operator may apply force on the flange 149 of the sleeve 128 to move the sleeve 128 axially towards the first end of the second shaft 130 until the mating structures 158 and 160 in the sleeve 128 engage with the first engagement structure 146. When the mating structures 158 and 160 are engaged with the first engagement structure 146, the sleeve 128 covers only the portion of the second shaft 130. In an embodiment, in such a scenario, the sleeve 128 releases the first shaft 126. Therefore, the second shaft 130 can be articulated on application of force. For example, the operator may apply the force on the joystick handle 118 to articulate the joystick handle 118 to the folded state. Further, in the folded state, the second shaft 130 engages with the clip 124 in such a manner that the clip 124 restricts the articulation movement of the joystick handle 118 and the second shaft 130.

The disclosed embodiments encompass numerous advantages. As the joystick handle 118 can be switched between the upright state and the folded state, the joystick handle 118 can be folded when the joystick handle 118 is not in use. Therefore, the possibility of falling debris damaging the joystick assembly 116 reduces in comparison to the conventional techniques where the joystick assembly 116 is always configured in the upright state. Further, as the sleeve 128 is slidably disposed on the second shaft 130, the sleeve 128 may be adapted to slide between the first engagement structure 146 and the second engagement structure 148 (without necessarily a need for a threaded connection between the sleeve 128 and the second shaft 130). This allows quicker switching between the folded state and the upright state in comparison to the conventional techniques.

While aspects of the present disclosure have been particularly shown and described with reference to some implementations above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. A folding assembly for an actuation lever, comprising:
a first shaft;
a second shaft pivotally coupled to the first shaft to allow articulation of the second shaft relative to the first shaft, wherein the second shaft comprises:
a first engagement structure, and
a second engagement structure spaced apart from the first engagement structure; and
a sleeve slidably disposed around the first shaft and the second shaft, wherein the sleeve comprises:
a mating structure adapted to engage with the first engagement structure or the second engagement structure,
wherein the sleeve is configured to cover a portion of the first shaft and a first portion of the second shaft, when the mating structure is engaged with the second engagement structure, and
wherein the sleeve is adapted to cover a second portion of the second shaft such that the sleeve releases the first shaft, when the mating structure is engaged with the first engagement structure.

2. The folding assembly of claim 1, wherein the sleeve has an outer surface and an inner surface, wherein the sleeve comprises at least one bore, radially extending from the outer surface of the sleeve to the inner surface of the sleeve, adapted to receive the mating structure, wherein a longitudinal axis of the at least one bore is perpendicular to a longitudinal axis of the sleeve.

3. The folding assembly of claim 2, wherein the sleeve further comprises a flange perpendicular to the longitudinal axis of the second shaft, and wherein the flange includes the at least one bore adapted to receive the mating structure.

4. The folding assembly of claim 1, wherein the mating structure includes a ball-catch assembly.

5. The folding assembly of claim 1, wherein the first engagement structure and the second engagement structure correspond to at least one of a recess or a groove that is adapted to engage with the mating structure.

6. The folding assembly of claim 1, wherein the second shaft is adapted to be articulated to a folded state when the mating structure is engaged with the first engagement structure.

7. The folding assembly of claim 6 further comprising a clip adapted to restrict the articulation of the second shaft when the second shaft is in the folded state.

8. The folding assembly of claim 1, wherein the second shaft is in a upright state when the mating structure is engaged with the second engagement structure.

9. A joystick assembly comprising:
a joystick handle;
a folding assembly, wherein the folding assembly comprises:
a first shaft;
a second shaft having a first end portion and a second end portion, the first end portion being adapted to receive the joystick handle, wherein the second shaft is pivotally coupled to the first shaft at the second end portion to allow articulation of the second shaft and the joystick handle relative to the first shaft, wherein the second shaft comprises:
a first groove formed on an outer surface of the second shaft, and
a second groove formed on the outer surface of the second shaft,
wherein the second groove is spaced apart from the first groove; and
a sleeve slidably disposed around the first shaft and the second shaft, wherein the sleeve comprises:
a ball-catch assembly adapted to engage with the first groove or the second groove,
wherein the sleeve is adapted to cover a portion of the first shaft and a first portion of the second shaft, when the ball-catch assembly is engaged with the second groove, and
wherein the sleeve is adapted to cover a second portion of the second shaft such that the sleeve releases the first shaft, when the ball-catch assembly is engaged with the first groove.

10. The joystick assembly of claim 9, wherein the sleeve has an outer surface and an inner surface, wherein the sleeve comprises at least one bore, radially extending from the outer surface of the sleeve to the inner surface of the sleeve, adapted to receive the ball-catch assembly, wherein a longitudinal axis of the at least one bore is perpendicular to a longitudinal axis of the sleeve.

11. The joystick assembly of claim 10, wherein the ball-catch assembly is threadably received in the at least one bore.

12. The joystick assembly of claim 10, wherein the sleeve further comprises a flange perpendicular to the longitudinal axis of the second shaft, and wherein the flange includes the at least one bore.

13. The joystick assembly of claim 9, wherein the second shaft and the joystick handle is adapted to be articulated to a folded state when the ball-catch assembly is engaged with the first groove.

14. The joystick assembly of claim 13, wherein the folding assembly comprises a clip structured and arranged to restrict the articulation of the second shaft and the joystick handle when the second shaft is in the folded state.

15. The joystick assembly of claim 9, wherein the second shaft is in a upright state when the ball-catch assembly is engaged with the second groove.

16. The joystick assembly of the claim 9, wherein the sleeve is adapted to slide between the first groove and the second groove on application of an external force on the sleeve.

17. The joystick assembly of claim 16, wherein the ball-catch assembly disengages from the first groove or the second groove when the external force is applied to the sleeve.

18. The joystick assembly of the claim 9, wherein the joystick handle is threadably coupled to the second shaft.

19. A joystick assembly comprising:
a joystick handle;
a folding assembly, wherein the folding assembly comprises:
a first shaft;
a second shaft having a first end portion and a second end portion, the first end portion being adapted to receive the joystick handle, wherein the second shaft is pivotally coupled to the first shaft at the second end portion to allow articulation of the second shaft and the joystick handle relative to the first shaft, wherein the second shaft comprises:
a first groove formed on an outer surface of the second shaft, and
a second groove formed on the outer surface of the second shaft,
wherein the second groove is spaced apart from the first groove;
a sleeve slidably disposed around the first shaft and the second shaft, wherein the sleeve comprises:
a ball-catch assembly adapted to engage with the first groove or the second groove,
wherein the sleeve is adapted to cover a portion of the first shaft and a first portion of the second shaft, such that the articulation of the second shaft is restricted by the sleeve, when the ball-catch assembly is engaged with the second groove, wherein the second shaft is in an upright state when the ball-catch assembly is engaged with the second groove, and
wherein the sleeve is adapted to cover a second portion of the second shaft such that the sleeve releases the first shaft, such that the articulation of the second shaft is allowed, when the ball-catch assembly is engaged with the first groove, wherein the second shaft is adapted to be in a folded state when the ball-catch assembly is engaged with the first groove; and
a clip structured and arranged to restrict the articulation of the second shaft and the joystick handle when the second shaft is in the folded state.
